(19) United States
(12) Patent Application Publication
(10) Pub. No.: US 2011/0313969 A1
(43) Pub. Date: Dec. 22, 2011

(54) UPDATING HISTORIC DATA AND REAL-TIME DATA IN REPORTS

(76) Inventor: GOWDA TIMMA RAMU, Bangalore (IN)

(21) Appl. No.: 12/817,218

(22) Filed: Jun. 17, 2010

(51) Int. Cl. G06F 17/30

(52) U.S. Cl. 707/602; 707/E17.005

(57) ABSTRACT

Disclosed are methods and systems for updating a report with real-time data. The method and systems involve receiving a request to view both historic data and real-time data in the report, identifying one or more data objects associated with the request, identifying one or more ETL jobs associated with the identified one or more data objects, determining a delta ETL job associated with the identified one or more ETL jobs and a upload timestamp of a delta ETL job, generating a data warehouse query based on the upload timestamp of the delta ETL job, generating a real-time query based on the transformations in the one or more ETL jobs and the upload timestamp of the delta ETL job, executing queries of the data warehouse query and real-time query to obtain historic data and real-time data and updating the report with both real-time data and historic data.

### FIELD

The field generally relates to updating reports and more specifically to updating real-time data and historic data in reports.

### BACKGROUND

Reporting and analysis techniques in an organization create massive data in a data warehouse. The data warehouse uses Extract Transform Load (ETL) applications to extract, transform and load the data into the data warehouse. The data in the data warehouse is in the format suitable for a user to analyze whereas in a transaction database the data is stored in the form of transactions. The data warehouse ETL jobs are resource consuming which may negatively affect the performance of the transactional system. Based on the organizational need, the ETL jobs are run in a batch either daily or weekly. Therefore historic data in the data warehouse includes data up to the last ETL job that was run. It is not feasible to run the entire ETL job for the data warehouse to get real-time data associated with the transactional system.

Though there are Enterprise Information Integration (EII) tools available which can provide real-time data they have to be implemented separately from the ETL tools. When implemented separately there is no link between the data warehouse and the EII tool. Therefore, the historic data from the data warehouse and the real-time data from the transaction system cannot be combined together in the report.

The user may want integration of real-time data from the transaction databases and the historic data from the data warehouse for some critical business decisions.

### SUMMARY

Various embodiments of systems and methods for updating real-time data in reports are described herein. The methods and systems involve receiving a request to view both historic data and the real-time data in a report, identifying one or more data objects associated with the request, identifying one or more ETL jobs associated with the identified one or more data objects, determining a delta ETL job associated with the identified ETL jobs and a upload timestamp of a delta ETL job, generating a data warehouse query based on the upload timestamp of the delta ETL job, generating a real-time query on the transformations in the one or more ETL jobs and the upload timestamp of the delta ETL job, executing queries of the data warehouse query and real-time query to obtain historic data and real-time data and updating the report with both real-time data and historic data.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments, together with their advantages, may be best understood from the following detailed description taken in conjunction with the accompanying drawings.

FIG. 1 is a flow diagram illustrating an exemplary method for updating reports with historic data and real-time data according to an embodiment.

FIG. 2 is a flow diagram illustrating an exemplary method for updating real-time data in reports according to an embodiment.

FIG. 3 is a flow diagram illustrating an exemplary method to identify one or more data objects in the request for historic data and real-time data according to an embodiment.

FIG. 4 is a block diagram illustrating an exemplary process for back tracking one or more data objects associated with the request for historic data and real-time data to a source table according to an embodiment.

FIG. 5 is a block diagram of an exemplary system to update real-time data according to an embodiment.

FIG. 6 is a block diagram of an exemplary computer system according an embodiment.

### DETAILED DESCRIPTION

Embodiments of techniques for updating real-time data to a report are described herein. In the following description, numerous specific details are set forth to provide a thorough understanding of various embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

A data warehouse is a database designed for query and report analysis rather than for transaction processing. The data warehouse includes historic data derived from a transaction system. The data warehouse may also include data from other data sources. The data warehouse environment usually includes an extraction, transformation, and loading (ETL) solution, an online analytical processing (OLAP) engine, and other applications that manage the process of gathering data and delivering it to business users.

A report refers to information automatically retrieved (i.e., in response to a query) from a data source (e.g., a database, a data warehouse, and the like), where the information is structured in accordance with a report schema that specifies the form in which the information should be presented.

ETL describes software tools that combine functions of extract, transform and load to migrate data. For example, the migration may be from one database to another database or to a data warehouse. ETL is a specific data transformation process. Extracting refers to the process of reading the data from a source (e.g., a database, data warehouse and the like). Transforming is the process of converting the extracted data from its previous form into the form it needs to be in and cleansing it so that it can be placed in the target (e.g., a new database or data warehouse). Transformation occurs by using rules or lookup tables or by combining the data with other data. Loading is the process of updating the data into the target.

Enterprise Information Integration (EII) tool retrieves data from several databases to create a single presentation. EII is a process of integrating information from different sources. The process relies on data abstraction to provide a single interface (known as uniform data access) for viewing all the data within an organization, and a single set of structures and naming conventions (known as uniform information representation) to represent this data; the goal of EII is to get a large set of heterogeneous data sources to appear to a user or system as a single, homogeneous data source. The EII tool allows a user to access data in different formats such as structured, semi-structured and unstructured. Structured data includes server based data. Semi-structured data includes emails and spread sheets. Unstructured data includes text documents and multimedia information. EII tools have the ability to combine data in different formats. For instance, EII tools can combine historic data from the data warehouse with the real-time data from the transaction systems. For instance, consider a user requesting to view a report including sales revenue for a period of three months. The sales revenue of the past three months is stored as historic data in a data warehouse whereas the sales revenue for the current time is generated dynamically from the transaction database.

On some occasions, combination of historic data and real-time data is required by a user to make business decisions with the most current information at hand. In such scenarios, the user requests for a report to be updated with both the historic data and the real-time data. To achieve this, the historic data from a legacy system and the real-time data from the transactional system may need to be combined in a meaningful way.

When a request comes from the user to view both historic data and real-time data, the ETL-EII module identifies one or more data objects associated with the user request. The ETL-EII module identifies a target table associated with the identified one or more data objects by comparing each data object with the data objects in the target table. The target table is a table including end results of several ETL jobs. Once the target table is found, the ETL-EII module initiates a back tracking process for the one or more ETL jobs which created the target table. The transformations in the ETL jobs are tracked to a source table. Identifying the transformations in the ETL jobs enables the user to request the real-time data for the data objects present in the transformations. Generally, the ETL jobs are run in batches according to a user need. The data warehouse house includes ETL jobs up to a last batch job run. The last batch job run of the ETL jobs is a most recent job run. According to one embodiment, the delta ETL job is a last batch of ETL jobs uploaded to the data warehouse. An upload timestamp of the delta ETL job is determined by ETL metadata. Based on the upload timestamp of the delta ETL job, a data warehouse query is generated. Based on the transformations in the identified ETL jobs and the upload timestamp of the delta ETL job, a real-time query for the transaction system is generated. Both the queries are nested within a single query. The queries are executed by the EII module.

The result of the data warehouse query is the historic data up to the upload timestamp of the last delta ETL job. The historic data is retrieved from the data warehouse. The result of the real-time query is the real-time data of the transformations in the identified ETL jobs. Using the upload timestamp of the delta ETL job, the transactional database presents data since the upload of last delta ETL job. For instance, if the most recent batch of ETL jobs was uploaded to the data warehouse on May 1, 2010 at 5:00 pm, the upload timestamp of the delta ETL job will be May 1, 2010 5:00 pm. When this timestamp is used by the real-time query to retrieve real-time data from the transactional database, the data updated after 5:00 pm of May 1, 2010 is retrieved. The report is updated with the real-time data and the historic data.

According to one embodiment, the report provides the user an option to select between a historic data report from the data warehouse and real-time data from the transaction databases on using a refresh option. When the user initiates the refresh option a flag is enabled. According to one embodiment, when the user requests a warehouse connection the flag is set to 0, else if the user requests an EII connection (i.e. real-time data from the transaction database along with the historic data from the warehouse) the flag is set to 1.

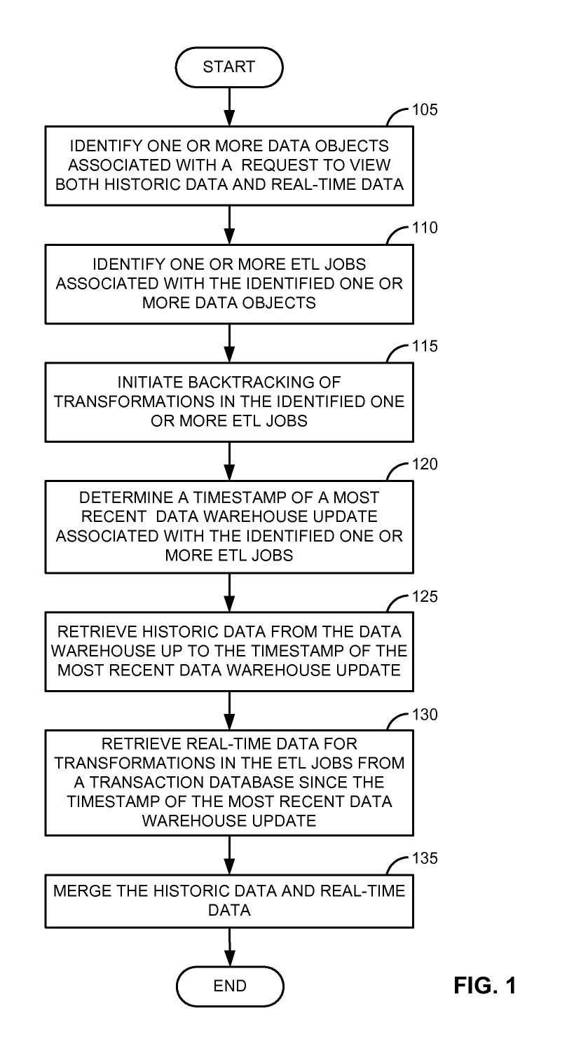

FIG. 1 is a flow diagram illustrating an exemplary method for updating reports with historic data and real-time data according to an embodiment. At process block 105, one or more data objects associated with a request to view both historic data and real-time data are identified. At process block 110, one or more ETL jobs associated with the one or more data objects are identified. Identifying the one or more data objects includes identifying a target table associated with them. At process block 115, the process of back tracking the transformations in the ETL jobs is initiated. The transformations in the ETL jobs are back tracked until they reach a source table. Back tracking identifies different data objects requiring real-time data. At process block 120, a timestamp of the most recent data warehouse update associated with the identified ETL jobs is determined. The timestamp is determined by ETL metadata. At process block 125, historic data is retrieved from the data warehouse up to the timestamp of the most recent data warehouse update. At process block 130, real-time data for the transformations in the ETL jobs are retrieved from a transaction database since the most recent data warehouse update. At process block 135, the historic data and the real-time data are merged. A report is updated with the merged historic data and the real-time data.

In an embodiment, the user request includes receiving a data event from the user. The data event triggers an action in the report.

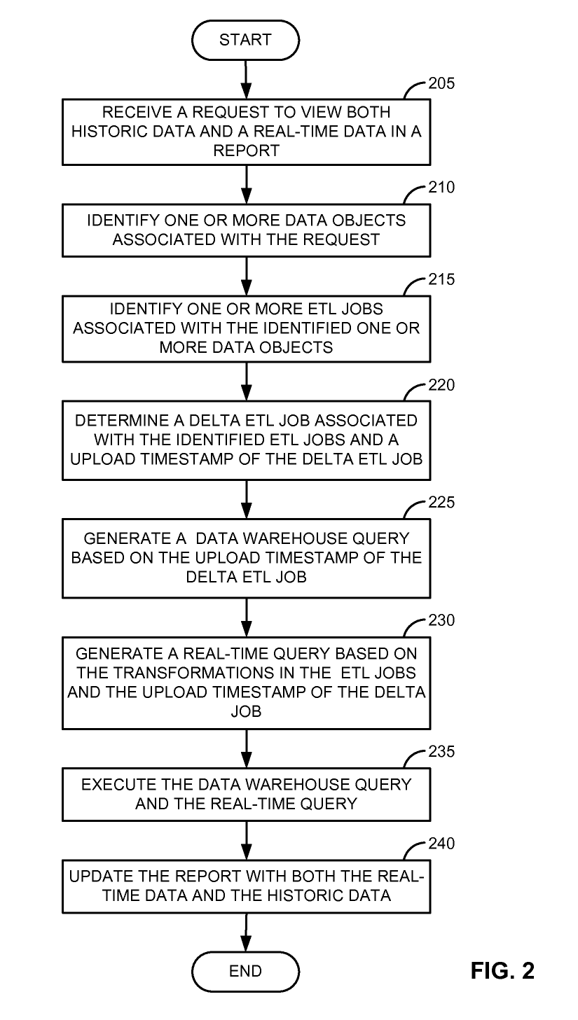

FIG. 2 is a flow diagram illustrating an exemplary method for updating real-time data in reports according to an embodiment. A request to view both historic data and real-time data in a report is received at process block 205. At process block 210, one or more objects associated with the request are identified. Identifying the one or more data objects involves identifying a target table associated with the one or more data objects. At process block 215, one or more ETL jobs associated with the one or more data objects are identified. The one or more ETL jobs include transformations of a different one or more data objects. The transformations in the identified one or more ETL jobs are tracked until they reach a source table. The transformations of the ETL jobs include computation of one or more data objects (e.g., summation, subtraction and so on). The real-time data is requested for the transformations in the identified ETL jobs. At process block 220, a delta ETL job associated with the identified one or more ETL jobs and a upload timestamp of the delta ETL job is determined. The upload timestamp of the delta ETL job is determined by ETL metadata. The delta ETL job is the most recent batch of ETL jobs uploaded to a data warehouse. At process block 225, a data warehouse query is generated based on the upload timestamp of the delta ETL job. At process block 230, a real-time query for the transaction database is generated based on the transformations in the one or more ETL jobs and the upload timestamp of the delta ETL job. This enables the transaction database to fetch real-time data for the one or more data objects in the transformations of the identified one or more ETL jobs. At process block 235, the data warehouse query and the real-time query are executed. The historic data is retrieved from the data warehouse and the real-time data is retrieved from the transaction database. At process block 240, the report is updated with both historic data and real-time data. The real-time data is updated in a format like that of the data warehouse format.

In an embodiment, receiving the request includes receiving a data event from the user. The data event triggers an action in the report. The data event is used in the real-time query during the execution to trigger an action. In another embodiment, receiving the request includes activating a refresh option in the report.

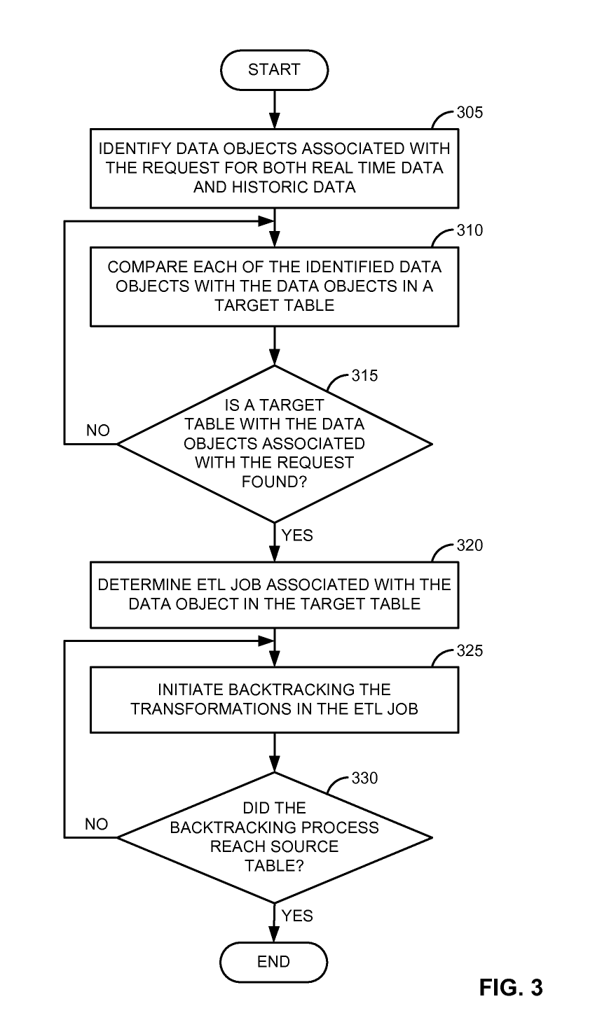

FIG. 3 is a flow diagram illustrating an exemplary method to identify one or more data objects in the request for historic data and real-time data according to an embodiment. At process block 305, data objects associated with the request for both historic data and real time data are identified. At process block 310, each data object associated with the request is compared with data objects in a target table. At decision block 315, if the target table with the data objects associated with the request is found, the process proceeds to process block 320, to determine the ETL job associated with the data object. At process block 325, the process of back tracking the ETL job is initiated. Back tracking identifies different data objects requiring real-time data. Back tracking involves the process of tracking the transformations of the ETL jobs to a source table. The transformations include a computation of one or more data objects. The transformations of the ETL job are tracked back to their source table. For instance, back tracking the identified ETL job may involve back tracking of more than one ETL job. If the target table with the data objects associated with the request is not found at the process block 315, the search at 310 is repeated until the data object is found in a target table.

At decision block 330, whether the data object is tracked to a source table is verified. If yes, the process ends. If not, the back tracking process at 325 is continued until the source table is found.

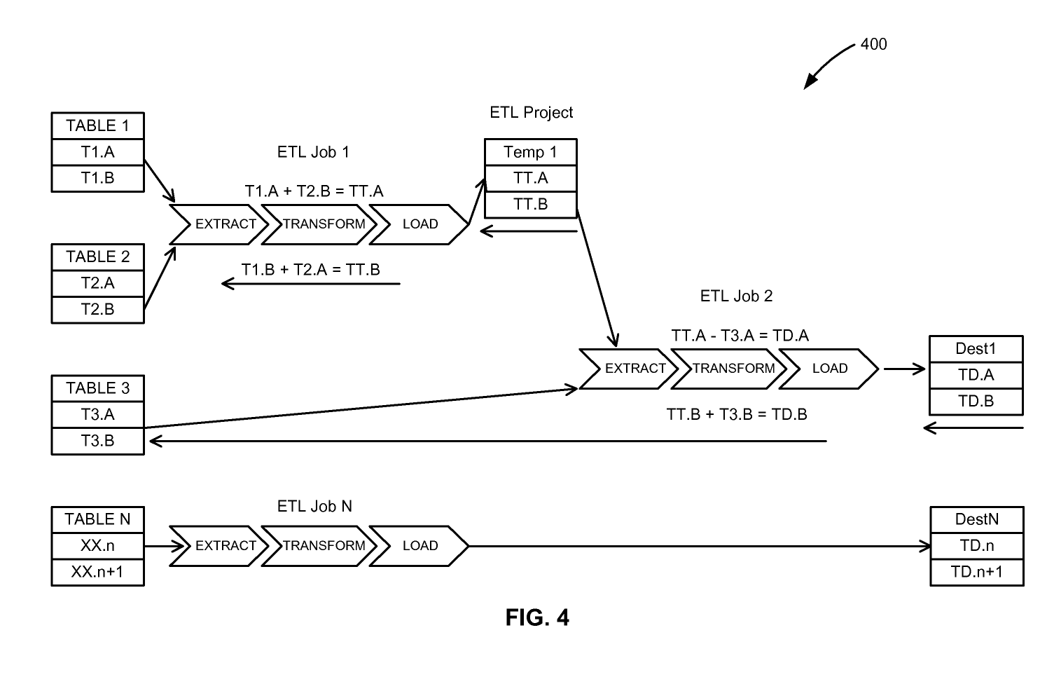

FIG. 4 is a block diagram illustrating an exemplary process for back tracking one or more data objects associated with the request for historic data and real-time data to a source table according to an embodiment. Consider a business scenario 400 where the user requests real-time data and historic data in the report. The user request is to view data of data object TD.A. The user has also requested the report to trigger an event when data object TD.B=1.

For viewing real-time data, the target table Dest1 associated with the data objects TD.A and TD.B is identified. First, the data object TD.A is back tracked to identify ETL jobs linked to it. In business scenario 400, the data object TD.A is tracked to ETL job2. The transformations in the ETL job2 are identified. The transformation for data object TD.A is a subtraction involving data objects TT.A and T3.A. The transformations of the ETL jobs are tracked until they reach a source table. For instance, tracking the data object T3.A ends when the source table (i.e. table 3) is reached.

Since the data object TT.A did not reach the source table, the data object TT.A is again tracked to ETL job1. The transformation for the data object TT.A is a summation involving data objects T1.A and T2.B. When all the data objects comprising TT.A (e.g., T1.A and T2.B) reached the source tables (i.e. table 1 and table 2, respectively) the tracking process ends. The real-time data is requested for data objects T1.A, T2.B and T3.A. The real-time data is retrieved from the transaction database.

The user has also requested an event to be triggered when data object TD.B becomes 1. The data object TD.B is back tracked to ETL job 2. The transformation of TD.B is a summation involving data objects TT.B and T3.B. Tracking the data object T3.B ends when the source table (i.e. table 3) is reached. The data object TT.B is tracked to ETL job1. The transformation of the data object TT.B is a summation involving data objects T1.B and T2.A. The tracking process ends when the source tables (i.e. table 1 and table 2) are reached. The real-time data for the data objects T3.B, T1.B and T2.A are retrieved and an event is triggered when the data object TD.B=1.

The real-time data for the identified data objects is retrieved based on the upload timestamp of the delta ETL job. The real-time data since the upload of last delta ETL job is retrieved from the transaction database. The historic data for the data object TD.A present in the data warehouse is also retrieved.

Consider a scenario, where a report includes profits of an industrial segment. When a user requests for a real-time data for profit of a particular industrial segment, the data objects associated with the profit are identified. The data objects of the profit may be revenue and expenses. The revenue and expenses data objects are back tracked to identify the other data objects associated with them. The other data object of the revenue may be sales generated. The other data object of the expenses may be expenses for packing and shipping. Assume that the most recent batch of delta ETL jobs including details of the profit was uploaded at 5:00 pm on May 2, 2010. Based on the upload timestamp of the delta ETL job, a database query is generated and the historic data for profit for a particular industrial segment is obtained as the result up to 5:00 pm of May 2, 2010. Now, the real-time data is fetched for transformations (i.e. sales generated, packing and shipping) of revenue and expenses from the transactional database. The real-time data results include real-time data (i.e. any change made to the data objects) after 5:00 pm of May 2, 2010. The real-time data is merged along with the historic data and presented to the user.

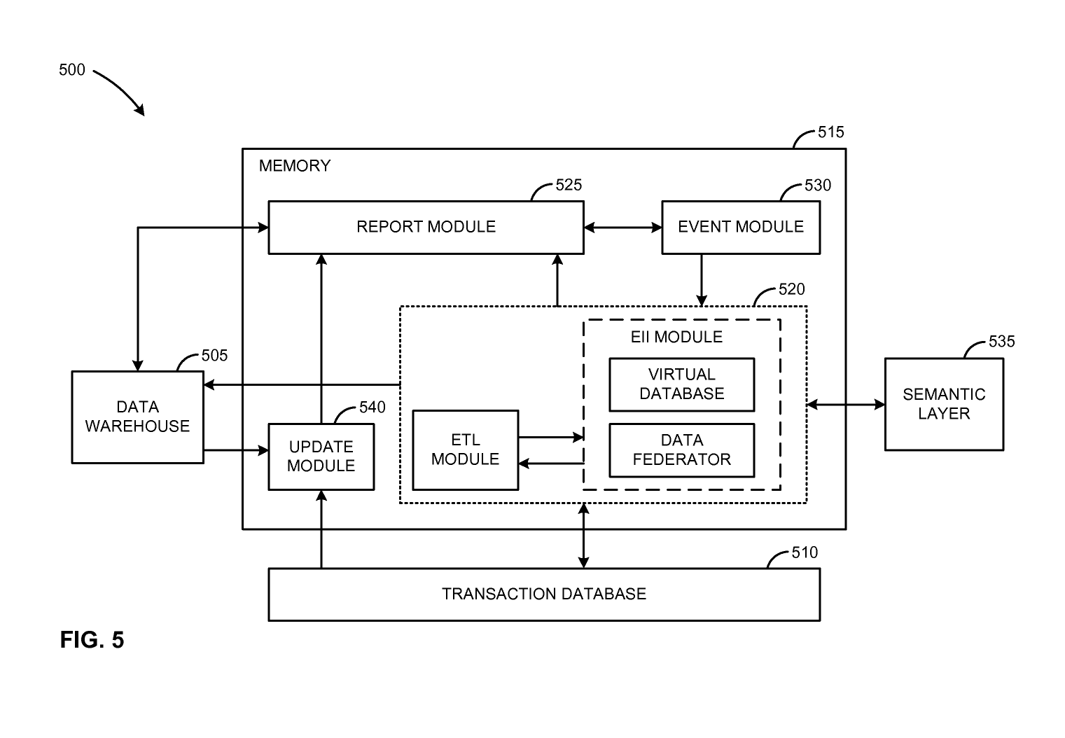

FIG. 5 is a block diagram of an exemplary system to update real-time data according to an embodiment. The computer system 500 includes a data warehouse 505, transaction database 510, a memory 515 and a semantic layer 535. The memory 515 includes an ETL-EII module 520, a report module 525, an event module 530 and an update module 540. The EII module in the ETL-EII module 520 may include a data federator and a virtual database.

A processor (not shown in the figure) in communication with the memory 515 may include instructions for the ETL-EII module 520, the report module 525, the event module 530 and an update module 540 to perform the required operations. The data warehouse 505 includes historic data. The transaction database 510 includes real-time data. The ETL-EII module 520 identifies one or more data objects associated with the request. According to one embodiment, the ETL-EII module 520 checks the semantics of the identified one or more data objects from the semantic layer 535. The report module 525 also provides an option to choose between a data warehouse connection and a real-time connection.

The ETL-EII module 520 identifies a target table associated with the identified one or more data objects. One or more ETL jobs linked to the identified one or more data objects are identified by the back tracking process. Identifying ETL jobs linked to the requested one or more data objects enables ETL operations to be performed on the required data objects rather than performing the ETL operations for the entire data warehouse. The one or more ETL jobs include transformations of different one or more data objects. The one or more ETL jobs are tracked back till it reaches a source table. The ETL-EII module 520 also determines a delta ETL job associated with the ETL job. The delta ETL job is the most recent batch of ETL jobs that were uploaded to the data warehouse. The upload timestamp of the delta ETL job is determined by ETL metadata. The ETL-EII module 520 generates a query for the data warehouse 505 based on the upload timestamp of delta ETL job. A real-time query for the transaction database 510 is generated based on the transformations in the ETL jobs and the upload timestamp of the delta ETL job. Both the queries are nested and executed by the EII module. The historic data and real-time data are generated. Both the real-time data and the historic data are updated to the report generated in the report module 530 using the update module 540. The real-time data is in the format like that of the data in the data warehouse.

In an embodiment, an event module 530 receives a data event from a user to trigger an action in the report. The event module 530 polls the transaction database 510 at regular intervals to trigger the action. In another embodiment, the real-time data may be requested by the event module 530.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer-readable media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

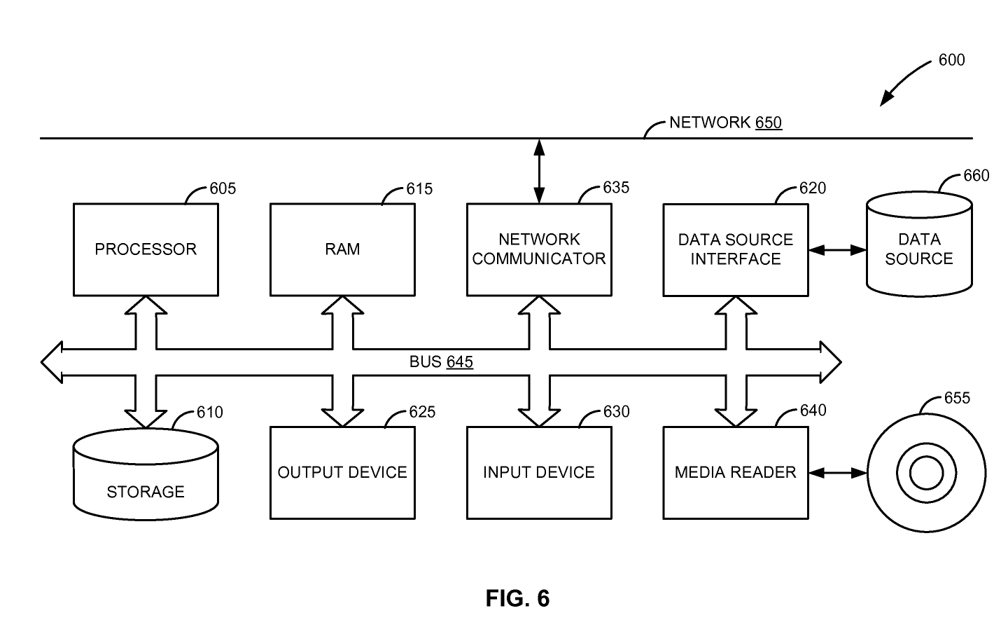

FIG. 6 is a block diagram of an exemplary computer system 600 according to an embodiment. The computer system 600 includes a processor 605 that executes software instructions or code stored on a computer readable storage medium 655 to perform the above-illustrated methods of the invention. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the invention, the computer system 600 further includes an output device 625 (e.g., a display) to provide at least some of the results of the execution as output including, but not limited to, visual information to users and an input device 630 to provide a user or another device with means for entering data and/or otherwise interacting with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however, that the invention can be practiced without one or more of the specific details or with other methods, components, techniques, etc. In other instances, well-known operations or structures are not shown or described in detail to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
receive a request to view a historic data and a real-time data in a report;
identify one or more data objects associated with the request;
identify one or more extract, transform and load (ETL) jobs associated with the identified one or more data objects, the one or more ETL jobs comprising transformations of a different one or more data objects;
determine a delta ETL job associated with the identified one or more ETL jobs and an upload timestamp of the delta ETL job, wherein the delta ETL job is a most recent batch of ETL jobs uploaded to a data warehouse;
based on the upload timestamp of the delta ETL job, generate a data warehouse query for the data warehouse;
based on the transformations in the one or more ETL jobs and the upload timestamp of the delta ETL job, generate a real-time query for a transaction database;
execute the data warehouse query and the real-time query to obtain the historic data and the real-time data; and
update the report with the historic data and the real-time data.

2. The article of manufacture in claim 1, wherein receiving the request comprises receiving a data event from a user for triggering an action in the report.

3. The article of manufacture in claim 1, wherein receiving the request comprises activating a refresh option on the report.

4. The article of manufacture in claim 1, wherein identifying the one or more data objects associated with the request comprises identifying a target table.

5. The article of manufacture in claim 1, wherein the real-time data comprises data since the upload of last delta ETL job.

6. The article of manufacture in claim 1, wherein the transformations of the one or more ETL jobs are tracked to a source table.

7. A computer system for updating historic data and real-time data to a report, the system comprising:
a data warehouse to store the historic data;
a transaction database to store the real-time data;
a processor;
a memory in communication with the processor, storing:
a report module to receive a request to view both the historic data and the real-time data in the report;
an extract, transform and load-enterprise information integration (ETL-EII) module to:
identify one or more data objects associated with the request;
identify one or more ETL jobs associated with the identified one or more data objects, the one or more ETL jobs comprising transformations of a different one or more data objects;
determine a delta ETL job associated with the one or more ETL jobs and an upload timestamp of the delta ETL job, the delta ETL job is a most recent batch of ETL jobs uploaded to the data warehouse;
based on the upload timestamp of the delta ETL job, generate a data warehouse query;
based on the transformations in the identified one or more ETL jobs and the upload timestamp of the delta ETL job, generate a real-time query for the transaction database;
execute the data warehouse query and the real-time query to obtain the historic data and the real-time data; and
an update module to update the report with both the historic data and the real-time data.

8. The computer system of claim 7, wherein the ETL-EII module identifies a target table associated with the identified one or more data objects.

9. The computer system of claim 7, wherein the transformations of the one or more ETL jobs are tracked to a source table.

10. The computer system of claim 7, wherein the memory comprises an event module to receive a data event from a user.

11. The computer system of claim 10, wherein the event module triggers an action in the report based on the data event.

12. The computer system of claim 7 further comprises a semantic layer.

13. The computer system of claim 12, wherein the semantic layer comprises semantics of the identified one or more data objects.

14. A computerized method for updating historic data and real-time data to a report, the method comprising:
identifying one or more data objects associated with a user request to view both the historic data and the real-time data;
identifying one or more extract, transform and load (ETL) jobs associated with the identified one or more data objects, the one or more ETL jobs comprising transformations of a different one or more data objects;
initiating a backtracking of the transformations in the identified one or more ETL jobs;
determining a timestamp of a most recent data warehouse update associated with the identified one or more ETL jobs;
based on the timestamp of the most recent data warehouse update, retrieving the historic data from a data warehouse up to the timestamp of the most recent data warehouse update;
retrieving the real-time data for the transformations in the one or more ETL jobs from a transaction database since the timestamp of the most recent data warehouse update; and
merging the historic data and the real-time data.

15. The computerized method of claim 14, wherein the user request comprises receiving a data event from the user.

16. The computerized method of claim 15, wherein receiving the data event from the user comprises triggering an action in the report.

17. The computerized method of claim 14, wherein identifying the one or more data objects comprises identifying a target table.

18. The computerized method of claim 14, wherein initiating backtracking of the identified one or more ETL jobs comprises tracking the ETL jobs to a source table.

19. The computerized method of claim 14, wherein the timestamp of the most recent data warehouse update is determined by an ETL metadata.

20. The computerized method of claim 14, wherein merging the historic data and the real-time data comprises updating the report with the historic data and the real-time data.
